(19) United States
(12) Patent Application Publication
(10) Pub. No.: US 2013/0080237 A1
(43) Pub. Date: Mar. 28, 2013

(54) SYSTEM AND METHOD FOR REWARDS PROGRAM FOR CREDIT CARD ISSUER

(71) Applicant: Michael J. HART, Marietta, GA (US)

(72) Inventor: Michael J. HART, Marietta, GA (US)

(21) Appl. No.: 13/678,286

(22) Filed: Nov. 15, 2012

Related U.S. Application Data
(63) Continuation-in-part of application No. 12/436,530, filed on May 6, 2009.
Application No. 12/436,530 is a continuation-in-part of application No. 11/916,896, filed on Dec. 7, 2007, now abandoned.
(60) Provisional application No. 60/689,483, filed on Jun. 10, 2005.

(51) Int. Cl. G06Q 30/02; G06Q 20/40

(52) U.S. Cl. CPC G06Q 30/0226
USPC 705/14.27

(57) ABSTRACT

The exemplary embodiments of the present invention provide a system and method for administering a rewards program. The system includes a computer system in communication with a network. The computer system includes a creation module that creates a reward account upon issuing a credit card from a credit card issuer, a reward adjusting module that adjusts the reward account when the credit card is used in a transaction, and a reward module that grants at least one reward transaction for the credit card issuer. The method includes creating a reward account upon issuing a credit card from a credit card issuer, adjusting the reward account when the credit card is used in at least one transaction, and coordinating at least one rewards transaction for the credit card issuer.

### CROSS-REFERENCE TO RELATED APPLICATION

This application is a continuation-in-part of U.S. Non-Provisional patent application Ser. No. 12/436,530, filed May 6, 2009 that is a continuation-in-part of U.S. Non-Provisional patent application Ser. No. 11/916,896, filed Dec. 7, 2007, which is a U.S. National Phase of International PCT Patent Application Serial No. PCT/US2006/021974, filed Jun. 6, 2006, which claims the benefit of U.S. Provisional Patent Application Ser. No. 60/689,483, filed Jun. 10, 2005, all of which are entirely incorporated herein by reference.

### BACKGROUND OF THE INVENTION

1. Field of the Invention

The present invention generally relates to rewards-based incentive programs; and more particularly to a program of delivering travel-related incentive awards to credit cardholders, employees and others by a credit card issuer (“CCI”), wherein payment for the travel is charged to a credit card issued by the CCI, providing a revenue stream for the CCI to recover a portion of the cost of the rewards program.

2. Description of Background

Currently, businesses or CCI's often give their cardholders and/or employees non-monetary and/or monetary rewards as incentives for spending habits, performance, for recognition of exemplary loyalty, for special occasions, and the like. Customers, service providers, and others may also receive non-monetary and/or monetary rewards from a business or CCI as an incentive to purchase goods or services, to increase business transactions, to increase credit/debit card transactions, to provide exceptional service, to meet critical deadlines, etc. Many of these rewards are in the form of prepaid travel, vacation packages, hotel stays, gift cards, and merchandise. For example, an employee who reaches a pre-determined reward level in a sales contest might receive an all-expense paid weekend trip to New York. In another example, a credit/debit card holder earns 25,000 points/miles on their card rewards program and receives a Free Roundtrip airline ticket anywhere in the domestic 48 states.

Rather than administering rewards programs in-house, many businesses and/or CCI's find it more efficient and effective to engage the services of a third-party rewards contractor. This typically reduces the administrative burden on the business, and may reduce costs considerably due to the rewards contractor's ability to negotiate volume-based discounts on airline tickets, event fees, hotel rooms, rental cars, and the like. The rewards contractor may have full and complete administration of the rewards program points/miles, marketing; call center, redemption processes, and fulfillment. Alternatively, the rewards contractor may only have responsibility for one or more aspects of the rewards program, such as the fulfillment of airline bookings. The business or CCI then allows the employees or cardholders to directly call the rewards contractor for the selection and fulfillment of the rewards item they would like to receive. The order is then taken and any points/miles that should be reduced from their points/miles pool will be removed and the accumulation process continues. All fulfillments would typically go directly to the person(s) who earned the reward from the rewards contractor.

For travel-based rewards, the rewards contractor may utilize the services of an outside travel agent, or may make the arrangements internally through a travel agent global distribution system (“GDS”) booking engine such as Sabre, Worldspan, Amadeus, etc. Such bookings typically require the booking agent to be trained in specialized code entries for the particular booking system. Because of their specialized training, these booking agents often must be more highly compensated than general customer service personnel. Also, the provider typically must settle payments for all travel bookings on a weekly cash basis through the an airline reporting company (“ARC”). There generally is no mechanism for recovering any portion of payments for bookings made in this manner.

While previously known rewards programs have met with differing degrees of success and acceptance in the field, it is recognized that continued innovation and advances are constantly sought by the marketplace. Thus it can be seen that needs exist for improvements to various aspects of rewards programs in general, and travel-based rewards programs in particular. It is to the provision of an improved rewards program meeting these and other needs that the present invention is primarily directed.

### SUMMARY OF THE INVENTION

Embodiments of the present invention provide a system and method for delivering rewards, such as for example travel-based loyalty rewards by a credit card issuer (“CCI”). In example forms, the system and method of the present invention generate a revenue stream from rewards bookings, enabling a CCI client of a rewards contractor to recover a portion of the overall cost of the rewards program. Example forms of the invention also allow rewards booking by personnel without specialized training in GDS coding, reducing plan administration costs. And example forms of the invention provide a more intuitive, user-friendly interface for program providers and participants, and also facilitate improved monitoring and control of program utilization and costs by the participating company and/or the rewards contractor.

Briefly described, in architecture, one embodiment of the system, among others, can be implemented as follows. The system includes a computer system in communication with a network. The computer system includes a creation module that creates a reward account upon issuing a credit card from a credit card issuer, a reward adjusting module that adjusts the reward account when the credit card is used in a transaction, and a reward module that grants at least one reward transaction for the credit card issuer.

Embodiment of the present invention can also be viewed as providing methods for administering a rewards program. In this regard, one embodiment of such a method, among others, can be broadly summarized by the following steps. The method includes creating a reward account upon issuing a credit card from a credit card issuer, adjusting the reward account when the credit card is used in at least one transaction, and coordinating at least one rewards transaction for the credit card issuer.

A further exemplary embodiment includes a computer program product for administering a rewards program. The computer program product comprises a storage medium readable by a processing circuit and storing instructions for execution by the processing circuit for performing a method. The method comprises creating a reward account upon issuing a credit card from a credit card issuer, adjusting the reward account when the credit card is used in a transaction; and coordinating at least one rewards transaction for the credit card issuer.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the rewards program for credit card issuer of the present invention.

FIG. 2A is a block diagram illustrating an example of a server utilizing the rewards program for credit card issuer of the present invention, as shown in FIG. 1.

FIG. 2B is a block diagram illustrating an example of a remote device utilizing the remote rewards program for credit card issuer system of the present invention, as shown in FIG. 1.

FIG. 3A is a block diagram illustrating an example of a flow for the rewards program for credit card issuer according to an example form of the present invention.

FIG. 3B is a block diagram illustrating an example of a flow for the rewards program according to an example form of the present invention.

FIG. 3C is a block diagram illustrating an example of a record storing the information used by the rewards program according to an example form of the present invention.

FIG. 4 is a flow chart illustrating an example of the operation of the rewards program for credit card issuer system for the host of the present invention utilized by the server, as shown in FIGS. 2A-3.

FIG. 5 is a flow chart illustrating an example of the operation of the configure process on the server that is utilized in the rewards program for credit card issuer system of the present invention, as shown in FIGS. 2A-4.

FIG. 6 is a flow chart illustrating an example of the operation of the reward collection process on the server that is utilized in the rewards program for credit card issuer system of the present invention, as shown in FIGS. 2A-4.

FIG. 7 is a flow chart illustrating an example of the operation of the reward processing process on the host that is utilized in the rewards program for credit card issuer system of the present invention, as shown in FIGS. 2A-4.

The detailed description explains the preferred embodiments of the invention, together with advantages and features, by way of example with reference to the drawings.

### DETAILED DESCRIPTION OF THE INVENTION

For The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Many banks, credit unions, brokerage houses, financial advisors, insurers, and other businesses are credit card issuers (CCI's). Like many businesses, these CCIs often reward their customers, employees, contractors and others, with incentives for making transactions on credit cards issued by the CCI, for loyalty, performance, etc., through a rewards contractor. For example, a cardholder user of a credit card issued by the CCI may earn “points” or “miles” for dollars spent or transactions made using their credit card, as part of an incentive rewards program offered by the CCI, and those points or miles may be redeemed by the cardholder user for rewards. The rewards may be in the form of travel-based rewards, and/or other forms of non-monetary or monetary awards. A rewards contractor may administer the rewards program for the CCI, and coordinate the transactions between the cardholder user redeeming an award and the vendor providing the reward products or services. Alternatively, the rewards program may be internally administered and the rewards coordinated by the CCI.

CCIs typically receive payment from vendors in the form of a percentage of the transactions made using credit cards issued by the CCI. The typical transaction/interchange rate received by a CCI through this channel ranges between 2 and 3 percent of every card transaction. The CCI typically pays a vendor the full transaction amount, less the transaction rate percentage; and collects the full transaction amount from the card user, thereby generating revenue equal to the transaction rate percentage of each purchase made on a card issued by the CCI.

According to the system and method of the present invention a credit card issuer client of a rewards contractor issues a credit card that is used as the form of payment for the travel bookings related to a rewards program administered by the rewards contractor. This designated rewards credit card issued by the CCI preferably will be used exclusively for all travel bookings made as part of the rewards program (i.e. a Credit Card that is Business, Consumer, Elite, Corporate and the like). The issued Credit Card is programmed into the travel website at a reward provider, such as for example but not limited to, a direct online booking agent that is branded for Ghost Card Setup. The website is hosted on a web host server (tangible storage medium).

This allows for the CCI to directly monitor and control expenses related to their rewards program. Additionally, it allows the CCI to realize a revenue stream, in the form of their transaction rate percentage, related to all the charges made on the designated rewards credit card. This revenue may be used to offset the overall cost of the rewards program, or for other purposes of the business. The ability for the CCI to recognize the additional revenue from this payment methodology is revolutionary in the rewards industry. Known programs typically rely on the provider settling travel bookings on a weekly cash basis through the Airline Reporting Company. The CCI receives no revenue stream from this standard form of rewards agreement. The rewards contractor can offer the CCI this revenue stream because the rewards contractor is preferably not using one of the usual travel agent booking engines like Sabre, Worldspan, Amadeus, etc., which typically require full cash settlement. Rather, the rewards contractor preferably has an agreement or relationship with a reward provider such as a direct online travel agent (“OTA”) such as for example Orbitz, to bypass the travel agent network, and preferably settles each travel booking at the time of purchase with the designated rewards credit card issued by the CCI for the rewards program. Direct arrangements are preferably made between the rewards contractor and the reward provider, for example in the form of one or more contracts for volume purchases of rewards such as airfares, hotel stays, rental cars, event tickets, and/or the like. The rewards are purchased preferably at discounted rates. Alternatively or additionally, arrangements are made between the rewards contractor and one or more vendors of reward components (such as airlines, hotel chains, rental car agencies, etc.), and/or between the reward provider and one or more vendors. The transaction with the OTA preferably includes a private special offer code or other identifier linked with the rewards contractor to access the negotiated discount arrangement in the transaction with the OTA.

The reward provider develops a rewards website for the designated rewards credit card where all rewards including Gift Card, Merchandise, Experiential Rewards, and Travel (Air, Hotel, Rental Car) can be redeemed. This website is hosted on a web host server and is embodied in a tangible storage medium. The reward provider provides a Single Sign On communication module with the OTA. This communication module is setup on a communication server at the reward provider and is embodied in a tangible storage medium.

The reward provider builds in the single sign on logic on the rewards website for the designated rewards credit card, whereby the end user can connect to the OTA website where travel bookings take place. This website is on a web host server and is embodied in a tangible storage medium. The end user for issued credit card must select a Rewards Option, on the rewards website that then uses a single sign on logic onto the OTA website and selects the desired reward (i.e. make a Air, Hotel or Rental Car booking and the like). This action invokes the charge onto the designated rewards credit card issued by CCI whereby the interchange from this transaction is returned to CCI as interchange revenue generated by the entire process outlined.

In an alternative embodiment, the end user can connect to a reward site for merchandise. Such merchandise includes, but is not limited to, Amazon website, specialized merchandise websites such as a particular online vendor.

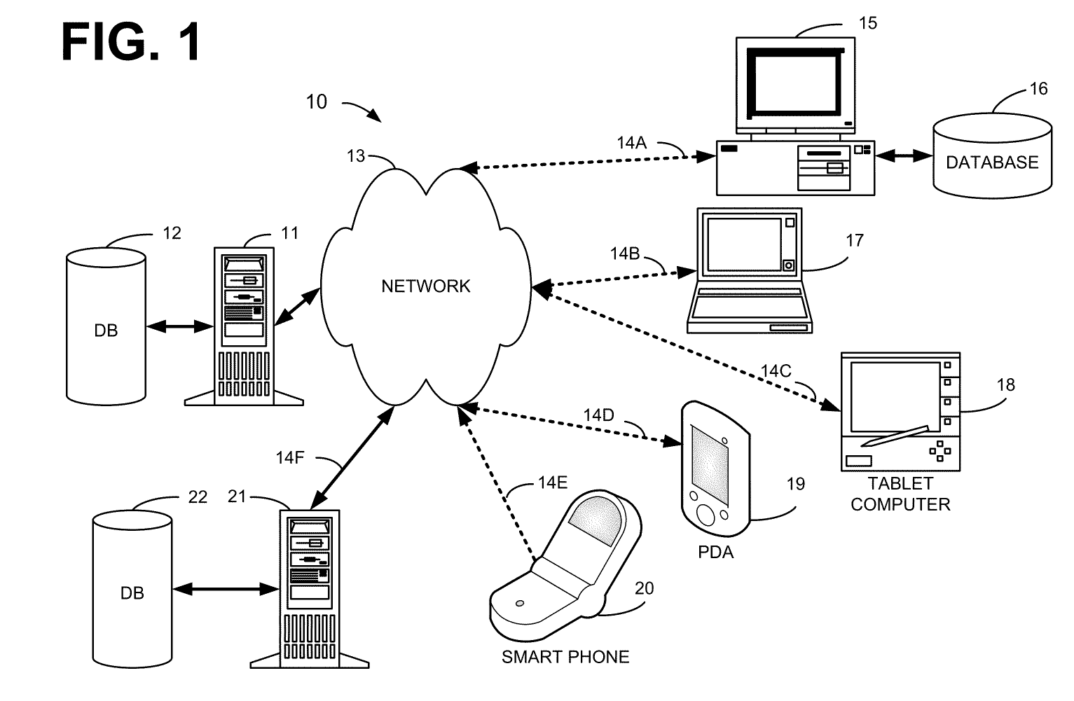

Referring now to the drawings, in which like numerals illustrate like elements throughout the several views. FIG. 1 illustrates an example of the basic components of a system 10 using the rewards program for credit card issuer system 100 used in connection with the preferred embodiment of the present invention. The system 10 includes a server 11 and the remote devices 15, 17, 18, 19, 20 or 21 that utilize the rewards program for credit card issuer system of the present invention.

Each remote device 15, 17-20 has applications and can have a local database 16. Server 11 contains applications, and a database 12 that can be accessed by remote device 15, 17-20 via connections 14(A-E), respectively, over network 13. The server 11 runs administrative software for a computer network and controls access to itself and database 12. The remote device 15-20 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization.

The remote device 15, 17-20 may each be located at remote sites. Remote device 15, 17-20 include but are not limited to, PCs, workstations, laptops, handheld computer, pocket PCs, PDAs, pagers, WAP devices, non-WAP devices, cell phones, palm devices, printing devices and the like.

Thus, when a user at one of the remote devices 15, 17-20 desires to access the reward program status from the database 12 at the server 11, the remote device 15, 17-20 communicates over the network 13, to access the server 11 and database 12.

The CCI computer systems 21/databases 22 and OTA booking can be accessed by the rewards program for credit card issuer system 100 on server 11 in order to access a direct online booking agent (“OTA”) engine 86, such as for example Orbitz or one or more vendors of reward components (such as airlines, hotel chains, rental car agencies, etc.). Data that is obtained from the CCI computer systems computer system 21 and database 22 can be stored on server 11 and database 12 in order to provide later access to the user on remote devices 15 and 17-20. It is also contemplated that for certain types of data that the user remote devices 15, 17- 20 can access the CCI computer systems 21 and database 22 directly using the network 13.

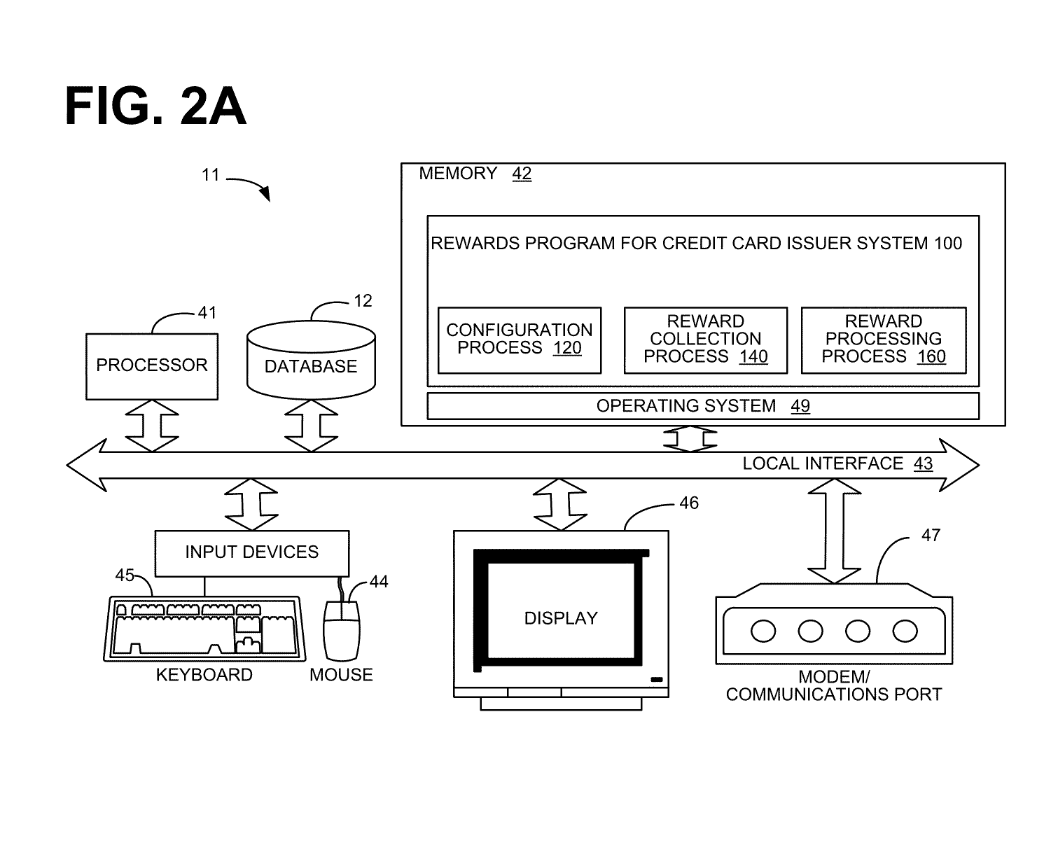

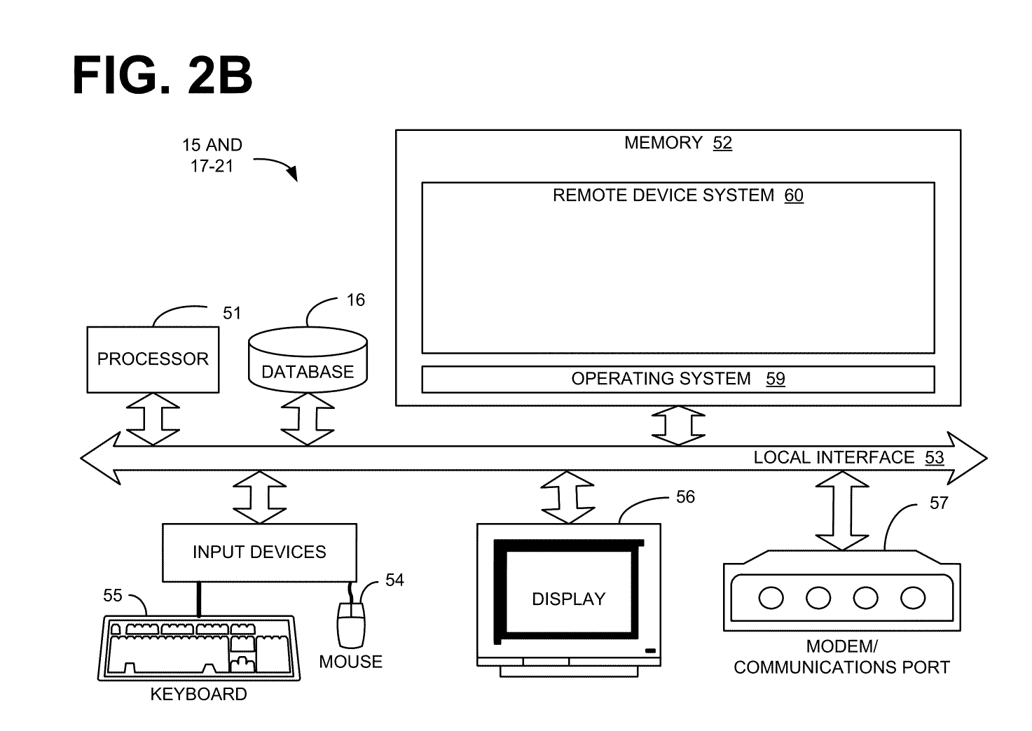

Illustrated in FIG. 2A is a block diagram demonstrating an example of server 11, as shown in FIG. 1, utilizing the rewards program for credit card issuer system 100 of the present invention. Server 11 includes, but is not limited to, PCs, workstations, laptops, PDAs, palm devices and the like. Illustrated in FIG. 2B is an example demonstrating a remote devices 15, 17-20 utilizing the remote rewards program for credit card issuer system 200 of the present invention. The processing components of the third party vendors computer systems 21 are similar to that of the description for the server 11 (FIG. 2A).

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and the rewards program for credit card issuer system 100 of the present invention. As illustrated, the rewards program for credit card issuer system 100 of the present invention comprises numerous functional components including, but not limited to, the configuration process 120, reward collection process 140 and reward processing process 160.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as the rewards program for credit card issuer system 100, and provides scheduling, input-output control, file and data management, memory management, and communication control and related services. However, it is contemplated by the inventors that the rewards program for credit card issuer system 100 of the present invention is applicable on all other commercially available operating systems.

The rewards program for credit card issuer system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49.

Furthermore, the rewards program for credit card issuer system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. The rewards program for credit card issuer system 100 and the O/S 49 are read, in whole or in part, by the processor 41, perhaps buffered within the processor 41, and then executed.

When the rewards program for credit card issuer system 100 is implemented in software, as is shown in FIG. 2A, it should be noted that the rewards program for credit card issuer system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the rewards program for credit card issuer system 100 is implemented in hardware, the rewards program for credit card issuer system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote device 15, 17-20, 21 that enables access to the rewards program for credit card issuer system 100 of the present invention, as shown in FIG. 2A. The remote devices 15 and 17-20 provides access to the rewards program for credit card issuer system 100 of the present invention on server 11 and database 12 using the remote devices system 60, including for example, but not limited to an Internet browser. The information accessed in server 11 and database 12 can be provided in the number of different forms including but not limited to ASCII data, WEB page data (i.e. HTML), XML or other type of formatted data. As illustrated, the remote device 15, 17-20 and 21 are similar to the description of the components for server 11 described with regard to FIG. 2A. Hereinafter, the remote devices 15, 17-20 and 21 that will be referred to as remote devices 15 for the sake of brevity.

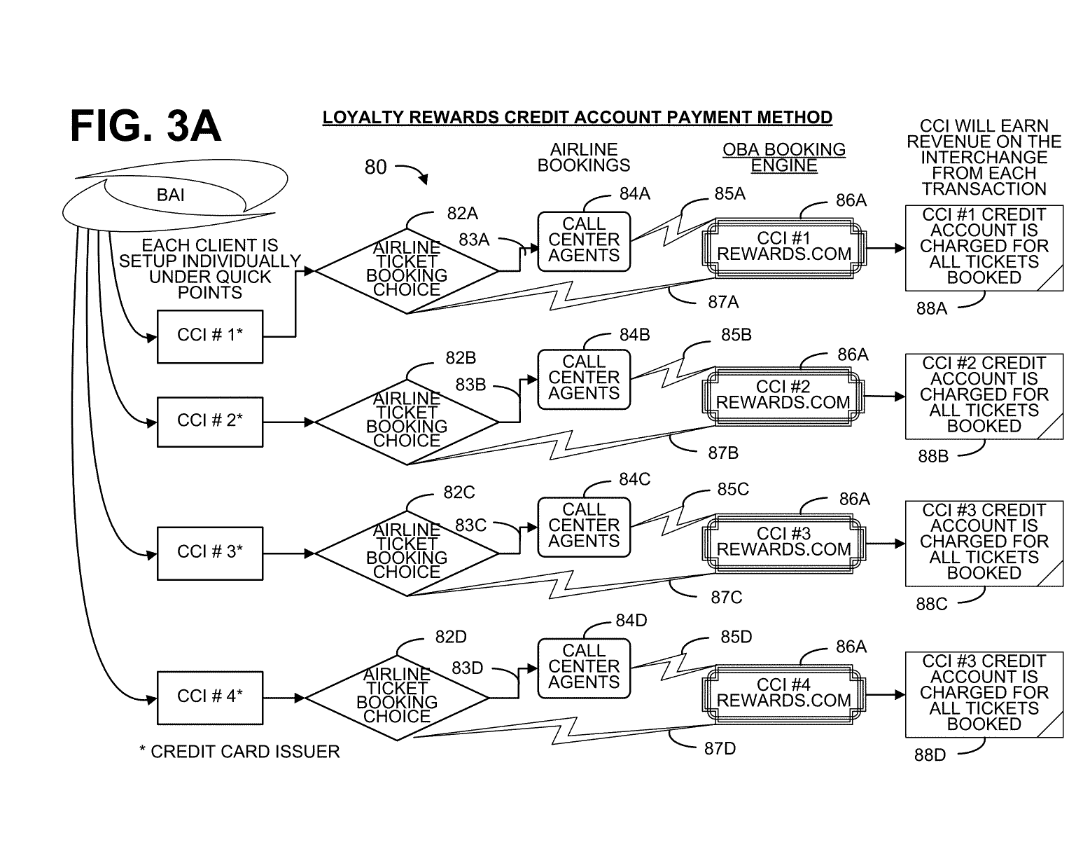

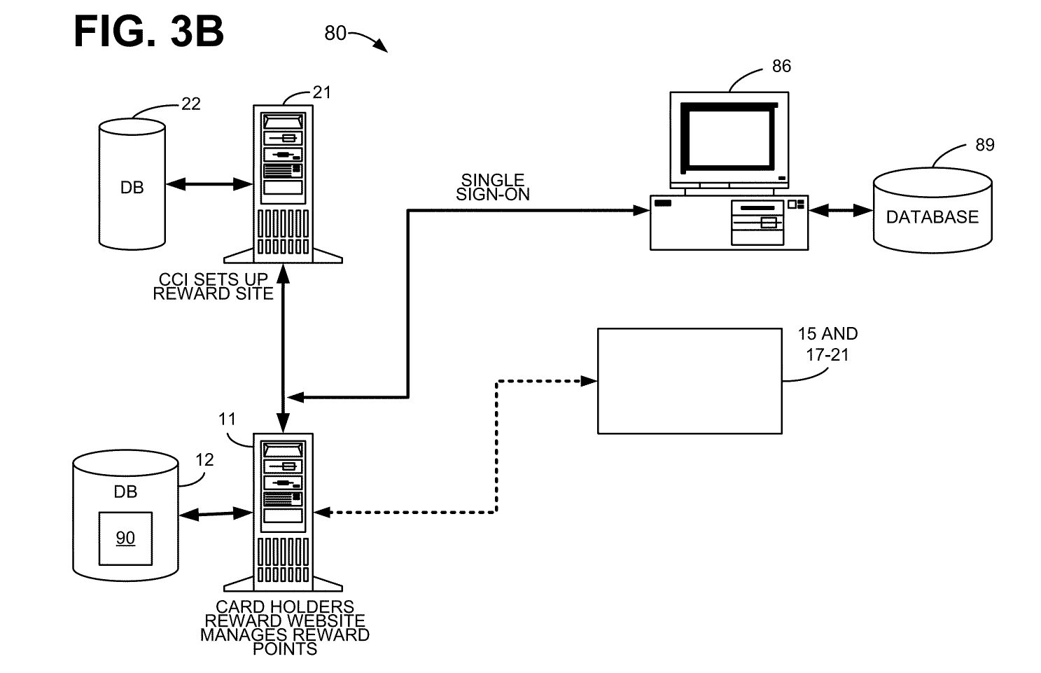

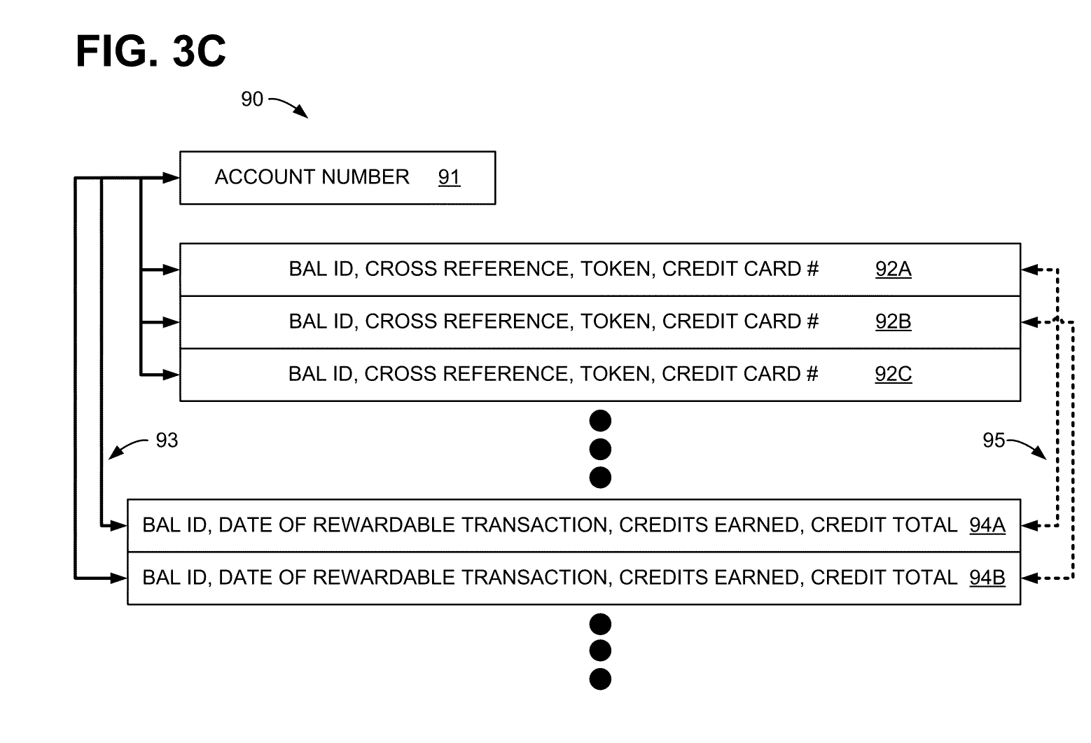

FIG. 3A is a block diagram illustrating an example of a flow 80 for the rewards program for credit card issuer system 100 according to an example form of the present invention. According to the flow 80, a reward recipient can preferably book a reward component such as an airline ticket by using either of the two methods as shown. Using the first such method, once a customer has made a booking choice 82, a customer can call into the rewards contractor's call center 83, and speak to an agent 84. The agent 84 then books the ticket 85 via the OTA booking engine 86 through a computer network, such as the Internet, or by telephone communication.

Using a second method, after a customer has made a booking choice 82, a customer can go online and click thru a link provided by the rewards contractor to access a branded website 87, and use the OTA booking engine 86 directly. In other methods, the customer can directly book their ticket or other rewards incentive by contacting the OTA booking engine 86 by telephone communication. The rewards contractor is issued a credit card account 88 by each CCI and that credit card is used exclusively to book travel for that CCI, whether booked by the rewards contractor or by the recipient through the website administered by the rewards contractor. The OTA preferably allows for the “setup” of various clients within a single business unit. This allows the rewards contractor to setup multiple CCI's.

The OTA agreement preferably allows for all rewards travel to be booked online through the OTA channel. For every booking made on the rewards program, the CCI can recover net revenue generated from the transaction/interchange fees associated with each travel transaction charged to the credit card they have assigned to the program. The travel provider or vendor, i.e., Delta Airlines, Hertz Rent-a-Car, Marriott Hotel, etc. preferably pays the transaction/interchange fees back to the CCI as part of the normal credit card transaction.

This new settlement methodology for the CCI allows for a revenue stream via the transaction/interchange fees to offset a portion of the rewards program costs. Revenues to the CCI will vary depending on the type of credit account used, but standard transaction/interchange rates would be in the range of 2-3 percent. Each CCI preferably then pays the balance on the credit card account with a method agreed to by the rewards contractor and the CCI, or alternatively the rewards contractor pays the credit card balance out of a previously collected program fee.

FIG. 3B is a block diagram illustrating an example of hardware used in the flow 80 for the rewards program 100 according to an example form of the present invention. Illustrated is server 21 and database 22 for a credit card issuer that issues a designated rewards credit card (i.e. a Ghost Card) that is used as the form of payment for the customer rewards program.

This designated rewards credit card issued by the CCI preferably will be used the rewards contractor exclusively for all reward costs made as part of the rewards program. This allows for the CCI to directly monitor and control expenses related to their rewards program. Additionally, it allows the CCI to realize a revenue stream, in the form of their transaction rate percentage, related to all the charges made on the designated rewards credit card. This revenue may be used to offset the overall cost of the rewards program, or for other purposes of the business. The ability for the CCI to recognize the additional revenue from this payment methodology is revolutionary in the rewards industry. The rewards contractor can offer the CCI this revenue stream because the rewards contractor is preferably not using one of the usual travel agent booking engines like Sabre, Worldspan, Amadeus, etc., which typically require full cash settlement. Rather, the rewards contractor preferably has an agreement or relationship with a reward provider such as a direct online travel agent (“OTA”) such as for example Orbitz, to bypass the travel agent network, and preferably settles each travel booking at the time of purchase with the designated rewards credit card issued by the CCI for the rewards program. Direct arrangements are preferably made between the rewards contractor and the reward provider, for example in the form of one or more contracts for volume purchases of rewards such as airfares, hotel stays, rental cars, event tickets, and/or the like. The rewards are purchased preferably at discounted rates. Alternatively or additionally, arrangements are made between the rewards contractor and one or more vendors of reward components (such as airlines, hotel chains, rental car agencies, etc.), and/or between the reward provider and one or more vendors. The transaction with the OTA preferably includes a private special offer code or other identifier linked with the rewards contractor to access the negotiated discount arrangement in the transaction with the OTA.

The reward provider develops a rewards website for the designated rewards credit card where all rewards including Gift Card, Merchandise, Experiential Rewards, and Travel (Air, Hotel, Rental Car) can be redeemed. This website is hosted on rewards contractor's server 11 using database 12. The rewards website allows customers of the CCI to obtain their awards using their reward points. In one embodiment, the website provides access to a direct OTA that is branded for the designated rewards credit card. The designated rewards credit card is programmed into the rewards contractor's server 11 that manages reward points for credit card usage by customers of the credit card issuer.

The reward provider uses a Single Sign On communication module with the OTA. This communication module is setup on a communication server at the reward provider and is embodied in a tangible storage medium.

The reward provider provides single sign on logic on the rewards website on server 11 for the designated rewards credit card, whereby the end user using remote device 15 connects to the OTA website where travel bookings take place. Using the single sign-on logic, the information on the OTA website appears within a area of the reward website. The OTA website is on server 86 and is embodied in database 89. The end user for issued credit card using remote device 15 selects a Rewards Option, on the rewards website that then uses the single sign on logic onto the OTA website and selects the desired reward (i.e. make a Air, Hotel or Rental Car booking and the like). This action invokes the charge onto the designated rewards credit card issued by CCI whereby the interchange from this transaction is returned to CCI as interchange revenue generated by the entire process.

FIG. 3C is a block diagram illustrating an example of a record 90 storing the information used by the rewards program 100 according to an example form of the present invention. Each record 90 includes an account number 91.

The credit card records 92 include a reward ID for identifying the award account, cross reference to the date of a workable transactions, credits earned and credits total for each credit card, a format-preserving security token representing the credit card number and the credit card number. In the preferred embodiment, the number can point to a group of credit cards for a particular entity. The entity may be corporate credit cards, credit cards within the same household and the like. The reward points records 94 include the reward ID for identifying the award account, the date of a reportable transaction, credits earned from that transaction and the total credits available.

In the preferred embodiment, the account number 91 uses pointers 93 to point to numerous other sub records that include credit card records 92 and reward points records 94. In another embodiment, the account number 91 uses pointers 95 two point to the credit card records 92. The credit card records 92 then use a cross reference field in the credit card record number 92 to 4 pointers 95 to reward points records 94.

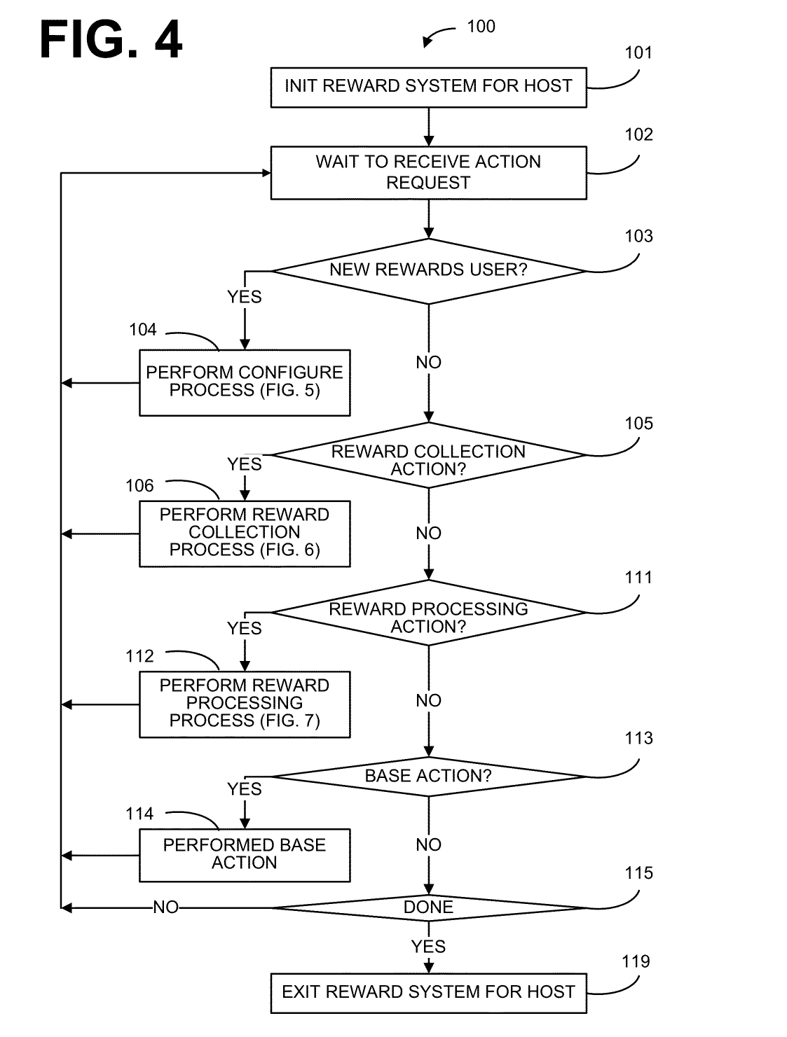

FIG. 4 is a flow chart illustrating an example of the operation of the rewards program for credit card issuer system 100 of the present invention utilized by the server 11, as shown in FIG. 2A. The rewards program for credit card issuer system 100 of the present invention provides instructions and data in order to create, collect and redeem reward points.

First at step 101, the rewards program for credit card issuer system 100 is initialized. This initialization includes the startup routines and processes embedded in the BIOS of the server 11. The initialization also includes the establishment of data values for particular data structures utilized in the rewards program for credit card issuer system 100.

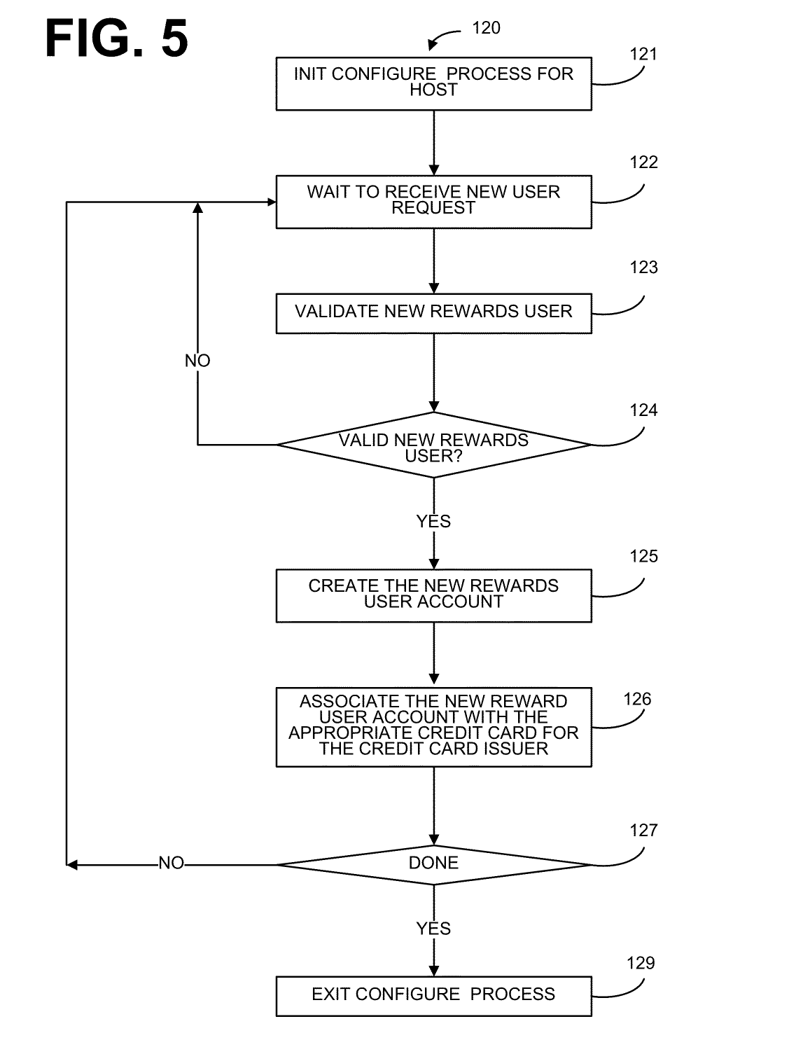

At step 102, the rewards program for credit card issuer system 100 waits to receive an action request. Once an action is received at step 102, it is determined if the action is to add a new reward user to the program at step 103. If it is determined that the action is not to add a new reward user to the program, then the rewards program for credit card issuer system 100 skip step 105. However, if it is determined in step 103 that a new reward user is to be added to the program action, then the rewards program for credit card issuer system 100 performs the configure process at step 104. The configure process is herein defined in further detail with regard to FIG. 5. After performing the configure process, the rewards program for credit card issuer system 100 returns to step 102.

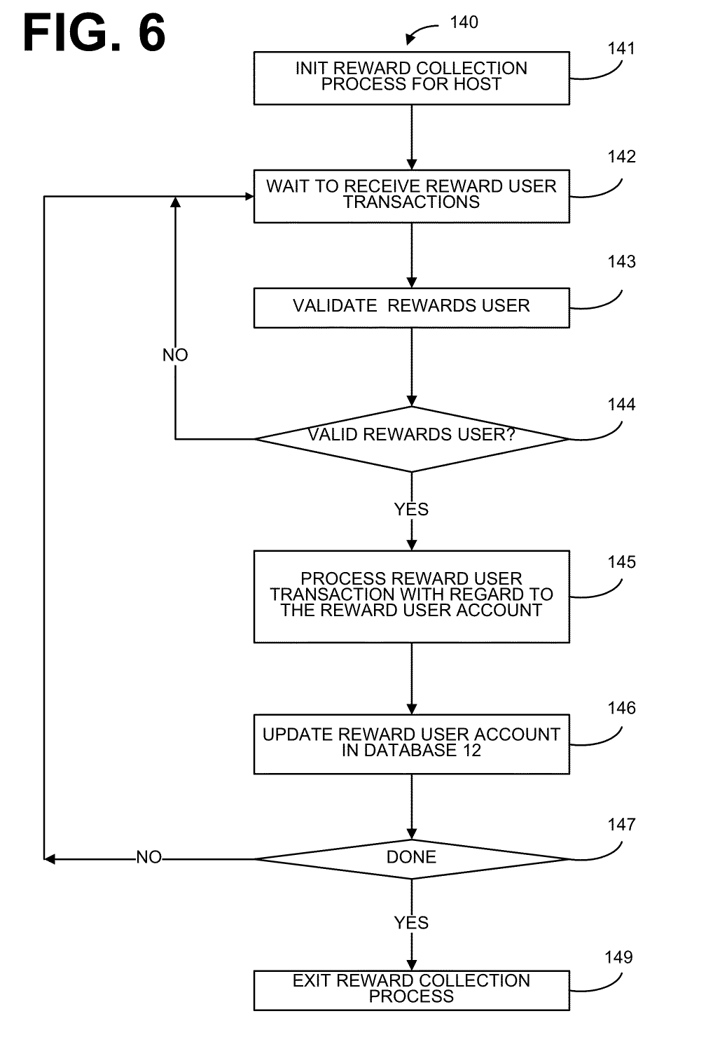

At step 105, it is determined if the action is a reward points collection action. If it is determined that the action is not a reward points collection action, then the rewards program for credit card issuer system 100 skip step 111. However, if it is determined in step 105 that it is a reward points collection action, then the rewards program for credit card issuer system 100 performs the reward collection process at step 106. The reward collection process is herein defined in further detail with regard to FIG. 6. After performing the reward collection process, the rewards program for credit card issuer system 100 returns to step 102.

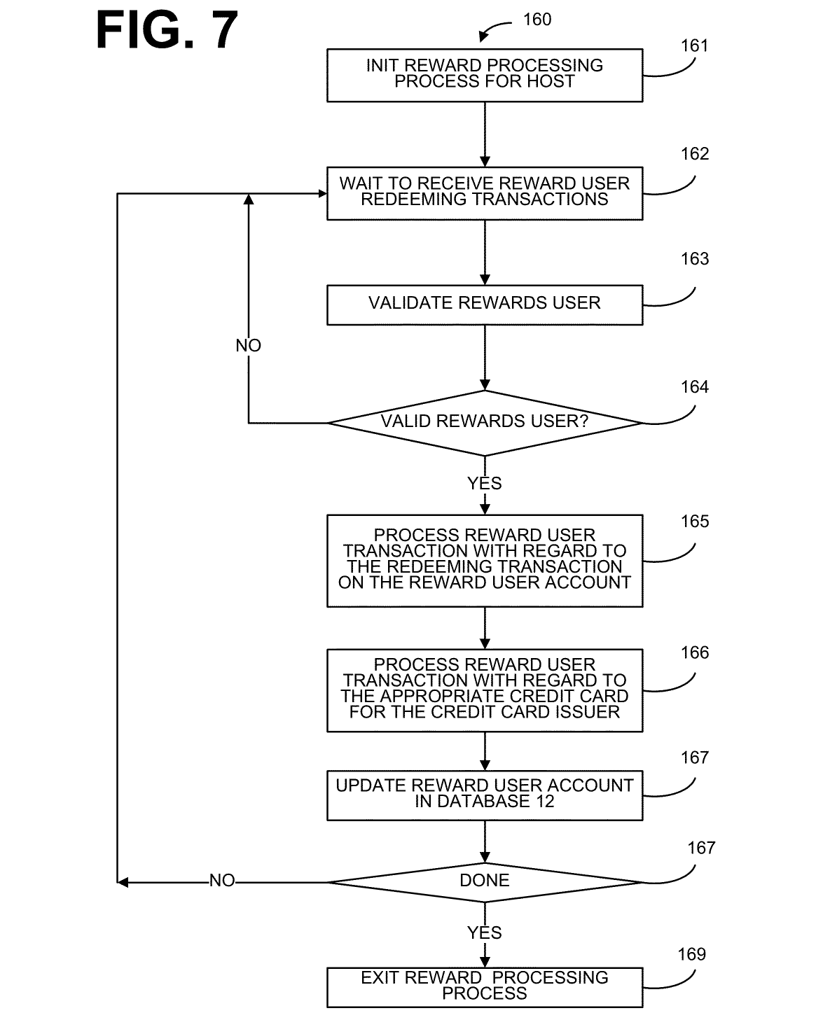

At step 111, it is determined if the action is a reward points processing action, i.e. a reward point redemption action. If it is determined that the action is not a reward point redemption action, then the rewards program for credit card issuer system 100 skip step 113. However, if it is determined in step 111 that it is a reward point redemption action, then the rewards program for credit card issuer system 100 performs the reward processing process at step 112. The reward processing process is herein defined in further detail with regard to FIG. 7. After performing the reward processing process, the rewards program for credit card issuer system 100 returns to step 102.

At step 113, it is determined if the action is a base action not explicitly defined in the rewards program for credit card issuer system 100 of the present invention. If it is determined that the action is not a base action, then the rewards program for credit card issuer system 100 skip this step 115. However, if it is determined at step 113 that a base action is to be performed, then the rewards program for credit card issuer system 100 performs the base action at step 114. After performing the base action, the rewards program for credit card issuer system 100 returns to step 102.

At step 115, it is determined if the rewards program for credit card issuer system 100 is to wait for additional action request. If it is determined at step 115 that the rewards program for credit card issuer system is to wait to receive additional actions, then the rewards program for credit card issuer system 100 returns to repeat steps 102 through 115. However, if it is determined at step 115 that there are no more actions to be received, then the rewards program for credit card issuer system 100 then exits at step 119.

FIG. 5 is a flow chart illustrating an example of the operation of the configuration process 120 on the server that is utilized in the rewards program for credit card issuer system 100 of the present invention, as shown in FIGS. 2A-4.

The configuration process 120 enables the creation of a new reward system user in place of the new user information in storage in database 12. Once the new reward user information is placed in server 11, it is available for reward credit collection and redemption. A brief overview of one exemplary process is as follows: 1) is user registered and logged in, if not, require login and/or registration; 2) Validate and store new reward user name; 3) upload new reward user information from local machine; 4) associate the new reward user account with the appropriate credit card for the credit card issuer; and 5) done.

First at step 121, the configuration process 120 is initialized. This initialization includes the startup routines and processes embedded in the BIOS of the server 11. The initialization also includes the establishment of data values for particular data structures utilized in the configuration process 120.

At step 122, the configuration process 120 waits to receive a new user request. Once a new user request has been received, the configuration process 120 then validates the new reward user at step 123. The new user is registered at this time and is validated against information in database 12 at step 124. If the new reward user is not valid, then the configuration process 120 returns to step 122. However, if the new reward user is valid, then the configuration process 120 enables the new rewards user to create a new reward user account at step 125.

At step 126, the configuration process 120 associates the new reward user account created at step 125 with the appropriate credit card for the credit card issuer of the new user.

At step 127, it is determined if the configuration process 120 is to wait for additional new user requests. If it is determined at step 127 that the configuration process 120 is to wait for additional new user requests, then the configuration process 120 returns to repeat steps 122 through 127. However, if it is determined at step 127 that there are no more new user actions to be received, then the configuration process 120 then exits at step 129.

FIG. 6 is a flow chart illustrating an example of the operation of the reward collection process 140 on the server that is utilized in the rewards program for credit card issuer system 100 of the present invention, as shown in FIGS. 2A-4. Once the new reward user is placed in server 11, it is available for reward credit collection. A brief overview of one exemplary process is as follows: 1) is user validated; 2) process reward users transaction with regard to the reward user account; 3) update the reward user account on database 12; and 4) done.

First at step 141, the reward collection process 140 is initialized. This initialization includes the startup routines and processes embedded in the BIOS of the server 11. The initialization also includes the establishment of data values for particular data structures utilized in the reward collection process 140.

At step 142, the reward collection process 140 waits to receive a reward user transaction. Once a reward user transaction has been received, the reward collection process 140 then validates the reward user at step 143. The user is registered at this time and is validated against information in database 12 at step 144. If the reward user is not valid, then the reward collection process 140 returns to step 142. However, if the reward user is valid, then the reward collection process 140 processes the reward user transaction with regard to the reward user's account at step 145. Examples of this include, but are not limited to, a user purchasing merchandise or services utilizing a credit card that would cause the reward user's account to be credited. However, in those instances where the reward user receives a refund on a transaction previously credited with reward points, then the reward user account is debited to reflect the refund.

In one embodiment, the crediting of a reward user's account may reflect pending reward credits as well as actual reward credits. Pending reward credits are those credits that are awarded in a transaction, but where the transaction has not have been paid for by the credit card user. The credit card issuer may desire only to issue reward credits to those transactions earning reward credits, where the credit card issuer receives payment for the reward credit earning transaction. This could prevent those rare instances of fraud being perpetrated to earn reward credits for transactions that the awardee never planned to pay for.

At step 146, the reward collection process 140 updates the reward user account in database 12.

At step 147, it is determined if the reward collection process 140 is to wait for additional user reward transactions. If it is determined at step 147 that the reward collection process 140 is to wait for additional user reward transactions, then the reward collection process 140 returns to repeat steps 142 through 147. However, if it is determined at step 147 that there are no more user reward transactions to be received, then the reward collection process 140 then exits at step 149.

FIG. 7 is a flow chart illustrating an example of the operation of the reward processing process 160 on the host that is utilized in the rewards program for credit card issuer system 100 of the present invention, as shown in FIGS. 2A-4.

Once the reward user has collected a sufficient reward credit amount then the user may redeem those credits in predetermined reward compensation plans. A brief overview of one exemplary process is as follows: 1) is user validated; 2) process reward users redeem mean transaction with the reward user account; 3) process the reward user transaction using the appropriate credit card for the credit card issuer; 4) update the reward user account on database 12; and 5) done.

First at step 161, the reward processing process 160 is initialized. This initialization includes the startup routines and processes embedded in the BIOS of the server 11. The initialization also includes the establishment of data values for particular data structures utilized in the reward processing process 160.

At step 162, the reward processing process 160 waits to receive a reward user transaction. Once a reward user transaction has been received, the reward processing process 160 then validates the reward user at step 163. The user is validated against information in database 16 at step 164. If the reward user is not valid, then the reward processing process 160 returns to step 162. However, if the reward user is valid, then the reward processing process 160 processes the reward user redeem transaction on the reward user's account at step 165. Examples of this include, but are not limited to, a user selecting merchandise or services utilizing credits in a reward user account.

At step 166, the reward processing process 160 then processes the reward user redeeming transaction with the appropriate credit card associated with the reward user account. Preferably, the appropriate credit card is determined by the credit card issuer at the time of user reward account creation. However, this can be changed by the credit card issuer to reflect a more favorable credit card to be utilized with each different type of transaction. For example, in an instance where the services being re-redeem include air travel. It is possible for the credit card issuer to associate a particular credit card providing the most generous transaction return for the credit card issuer.

At step 167, the reward processing process 160 updates the reward user account to reflect the credit redemption in database 12.

At step 168, it is determined if the reward processing process 160 is to wait for additional user redeeming transactions. If it is determined at step 168 that the reward processing process 160 is to wait for additional user redeeming transactions, then the reward processing process 160 returns to repeat steps 162 through 167. However, if it is determined at step 167 that there are no more user redeeming transactions to be received, then the reward processing process 160 then exits at step 169.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method of administering a rewards program embodied in a computer program product for execution on an instruction processing computer system, comprising a tangible storage medium readable by the instruction processing computer system and storing instructions for execution by the instruction processing computer system for performing said method comprising:
creating a cardholder reward account by the credit card issuer as part of a loyalty reward program in which reward points are earned and redeemed by the cardholder, the cardholder reward account stored in the tangible storage medium, the points are earned by the cardholder associated with purchases made with a cardholder credit card, the cardholder credit card being issued from a credit card issuer;
creating a reward program credit card account issued from the credit card issuer, the reward program credit card account being a single account used exclusively for payment of all loyalty reward program transactions for all cardholders participating in the program, the loyalty reward program transactions resulting from a loyalty program reward redemption by the cardholder, the rewards program credit card account stored in the tangible storage medium;
adjusting the cardholder reward account stored in the tangible storage medium when the cardholder reward account is used in at least one loyalty reward program transaction;
coordinating for the credit card issuer all loyalty reward program transactions associated with all cardholder reward accounts, wherein the reward program credit card account is used to pay for all loyalty reward program transactions, thereby generating transaction interchange revenue for each transaction amount to the credit card issuer.

2. The method of claim 1, further comprising granting a reward to a recipient.

3. The method of claim 2, wherein the credit card issuer designates the recipient.

4. The method of claim 1, wherein the credit card issuer receives a percentage of the payment for the rewards transaction.

5. The method of claim 1, wherein the coordinating of all loyalty reward program travel transactions is performed by accessing a website.

6. The method of claim 5, wherein the reward is a travel-based reward.

7. The method of claim 6, wherein the travel-based reward is obtained from a travel website using a single sign on.

8. The method of claim 1, wherein the reward is a merchandise provider.

9. A system for administering a rewards program, comprising:
a computer system in communication with a network, the computer system further comprising:
an instruction processing system;
a tangible storage medium readable by the instruction processing system and storing instructions for execution by the instruction processing;
a creation module stored in the tangible storage medium that when executed by the instruction processing system creates a cardholder reward account that is stored in the tangible storage medium that is associated with a cardholder credit card, the cardholder credit card being issued from a credit card issuer;
a reward adjusting module stored in the tangible storage medium that when executed by the instruction processing system adjusts the cardholder reward account when the cardholder credit card is used in a transaction;
a reward module as part of a loyalty reward program for the credit card issuer stored in the tangible storage medium that when executed by the instruction processing system grants each loyalty reward program transaction associated with each cardholder reward account redemption, wherein all reward transactions are paid for using a single reward credit card account issued by the credit card issuer, thereby generating transaction interchange revenue amounts to the credit card issuer for each loyalty reward travel redemption.

10. The system of claim 9, wherein the reward is granted to a recipient.

11. The system of claim 10, wherein the credit card issuer designates the recipient.

12. The system of claim 9, wherein the credit card issuer receives a percentage of the payment for the rewards transaction.

13. The system of claim 9, wherein the reward module interacts with a website to allow the cardholder to select their loyalty reward program transaction.

14. The system of claim 9, wherein the loyalty reward program transaction is a travel-based reward.

15. The system of claim 14, wherein the travel-based reward is obtained from a travel website using a single sign on.

16. The system of claim 15, wherein the loyalty reward program transaction is with a merchandise provider.
